(19) United States
(12) Patent Application Publication
(10) Pub. No.: US 2007/0086658 A1
(43) Pub. Date: Apr. 19, 2007

(54) Image processing apparatus and method of image processing

(76) Inventor: Manabu Kido, Osaka (JP)

Correspondence Address: SMITH PATENT OFFICE, 1901 PENNSYLVANIA AVENUE N W, SUITE 901, WASHINGTON, DC, 20006, US

(21) Appl. No.: 11/583,136

(22) Filed: Oct. 19, 2006

(30) Foreign Application Priority Data
Oct. 19, 2005 (JP) 2005-305084
Oct. 17, 2006 (JP) 2006-282288

(51) Int. Cl. G06K 9/48

(52) U.S. Cl. 382/199

(57) ABSTRACT

An image processing apparatus for extracting edge points in an input image acquired by an image acquisition device is presented. The image processing apparatus includes an edge magnitude threshold value specifying device for specifying an edge magnitude as an edge magnitude threshold value from the data of the edge magnitude corresponding to a criterion edge magnitude value and the number of the edge points to be extracted. The apparatus also includes an edge point extractor for extracting a pixel having an edge magnitude corresponding to the edge magnitude threshold value as one of the edge points in each pixel of the input image. An image processing method for extracting edge points in an input image acquired by an image acquisition device is also discussed.

This application claims foreign priority based on Japanese Patent Application No. 2005-305084, filed on Oct. 19, 2005 and Japanese Patent Application No. 2006-282288 filed on Oct. 16, 2006, the contents of which are incorporated herein by reference in their entirety.

### BACKGROUND OF THE INVENTION

1. Field of the Invention

This invention relates to a machine vision system, and especially, to a technique of extracting features of an image.

2. Description of the Related Art

A pattern search technique uses a pre-registered pattern image including a specific pattern, to search for a similar pattern to the specific pattern on an object image. This technique is used in various applications. For example, the pattern search technique is used as an inspection tool of a product. The inspection tool acquires product images with a camera in various kinds of product lines. Then, it searches for a similar pattern on the acquired product image as the pre-registered pattern image. As a result, the inspection tool using the pattern search technique is able to provide an automatic inspection system which checks whether a part is disposed on an exact position, or whether a specific printing condition is in an exact condition at an exact position.

In some of the pattern search techniques, since an edge of the image tolerates environmental fluctuation, the data regarding the edge is used as one of the features to be searched to improve the detecting ability of the search. In other words, a comparison of the acquired product image with the pre-registered pattern image is carried out by using a feature part having a rapidly changing intensity part as the feature portion that is evaluated on each image.

FIG. 12 shows a flow chart regarding processing of the detecting pattern in the prior art. First, a Sobel filter is adapted to an input image in the vertical direction and the horizontal direction to generate X elements and Y elements of the edge magnitude. Then, the edge element image consisting of the X element and the Y element of the edge magnitude is generated (Step S21). In other words, the image having the X element and the Y element of the edge magnitude at each pixel is generated.

Next, an edge magnitude image is generated from the edge element image obtained in Step S21. In other words, the image having an edge magnitude at each pixel is generated.

Next, the pixels having the edge magnitude above an edge magnitude threshold value are chosen by the operator specifying the threshold value. A group of the chosen pixels is determined as the feature points (Step S23).

Finally, the specific pattern comprised in the feature points determined in Step S23 is detected by searching using the pre-registered pattern image (Step S24).

In this way, the searching process is adapted to the image having the edge magnitude above the edge magnitude threshold value instead of the entire input image. Using the above mentioned process, the processing speed improves.

Japanese Laid-open Patent Publication No. H09-6971 discloses a technique of extracting features of an object without an edge magnitude threshold value.

Japanese Laid-open Patent Publication No. 2003-109003 discloses a technique of pattern matching by displaying the process parameters set by the machine vision system on a display and changing the process parameters by an operator.

### SUMMARY OF THE INVENTION

The process shown in FIG. 12 can improve the processing speed since the pattern search is implemented based on limited feature points. However, the prior method is that the edge magnitude threshold value is fixed during the pattern search. This has a potential problem which is a declining detecting ability of the pattern search when the distribution of the edge magnitude of the input image changes, that are caused by an environmental fluctuation and so on.

For example, in the case that an input image is the image 100 as shown in FIG. 13, the image 100 of a printed circuit board comprises a printed character 101 printed on the printed board and a circuit pattern 102 formed in the printed board. The image 100 also includes small points 103. The points 103 may be points that actually existed on the printed board, or may be noise generated by image processing. Then, it supposes that the pattern to be detected is character “121” on the image 100. In other words, the pattern to be searched is included in the printed character 101.

When the pattern search is implemented for the image 100 processed as shown in FIG. 12, the problems described below can occur. For example, it supposes that the pattern search is implemented for the product image acquired on the product manufacturing line. Also, it supposes that the product image is acquired in a comparatively bright environment. FIG. 14 shows a frequency distribution 120 of an edge magnitude of the acquired image. The area 101A is the area distributing the edge magnitude of the image of the printed character 101, and the area 102A is the area distributing the edge magnitude of the image of the circuit pattern 102.

Then, it supposes that the edge threshold value is designated at the position as shown in FIG. 14. The area CP surrounded with the broken line shown in FIG. 14 is the area of the feature points since the points having an edge magnitude above the edge magnitude threshold value 121 are chosen as the feature points. In this case, the image of the circuit pattern 102 without the image of the printed character is chosen as the feature points in Step S23 because of the lower edge magnitude threshold value. It is also possible to admit that not only character “121” is to be searched but also the character “AB” can be extracted as the feature points. However, the image of the circuit pattern 102 is extracted as the feature points because of the lower edge magnitude threshold value. This is not preferred because the searching speed is lowered and the ability of detecting the pattern is reduced.

One of the methods to resolve this is to make the edge magnitude threshold value high. FIG. 15 shows the frequency distribution 120 of the same image as shown in FIG. 14. Here, the edge magnitude threshold value 122 is set and the area 102A is not extracted as part of the feature points. In other words, the area 102A is not included in the area CP indicating the feature points. In this way, when the edge magnitude is high or to a specific value, the circuit pattern 102 having a lower edge magnitude may not be extracted as the feature points. Thus only the printed character 101 may be extracted as the feature points.

However, this situation depends on the environment. For example, when it becomes dark, caused by a change in the illumination and so on, the edge element becomes weak since the intensity of the entire image becomes lower. FIG. 16 shows a frequency distribution 123 of the edge magnitude of the same image as shown in FIGS. 14 and 15 acquired in a dark environment. The frequency distribution 123 is biased lower than the frequency distribution 120 shown in FIGS. 14 and 15.

The areas 101A and 102A are also biased lower. In this case, when the upper edge magnitude threshold value is specified such as in the case of FIG. 15, not only the image of the circuit pattern 102 but also the image of printed character 101, may not be extracted as the feature points. In other words, as shown in FIG. 16, this situation has the potential that the area 101A is not extracted as the feature points. In this case, the pattern search for the character “121” has failed.

As in the above mentioned case, in the prior pattern search technique, both the processing speed of the pattern search and the ability of the detecting pattern become worse when the edge magnitude threshold value is too low. On the other hand, the illumination environment can also cause the detecting ability of the pattern search to become worse when the edge magnitude threshold value is set high.

The purpose of this invention is to provide an apparatus and technique for a pattern search, an automatic determination of a processing area, a shape inspection and so on, for extracting the features of an image which tolerates environmental changes and solves the above mentioned problems.

### BRIEF DESCRIPTION OF THE DRAWINGS

FIG. 1 shows a block diagram of a machine vision system according to the present invention.

FIG. 2 shows a block diagram of an IC for image processing.

FIG. 3 shows an image of a user interface for setting the extracting features regarding a pattern image.

FIG. 4 shows an image of a user interface for setting the extracting features regarding an input image.

FIG. 5 shows a flow chart of a process for detecting the pattern.

FIG. 6 shows a graph of a frequency distribution of the object in a bright environment.

FIG. 7 shows a graph of a frequency distribution of the object in a dark environment.

FIG. 8 shows a picture for explaining the local maxima of the edge and the points surrounding the local maxima.

FIG. 9 shows an image of a user interface for a pattern search image.

FIG. 10 shows a graph of a frequency distribution in the embodiment for specifying the upper value of the edge magnitude.

FIG. 11 shows a graph of a frequency distribution in the embodiment for determining the range of an edge magnitude from the mean value of the edge magnitude of the pattern image.

FIG. 12 shows a flow chart of the process of detecting the pattern in the prior art.

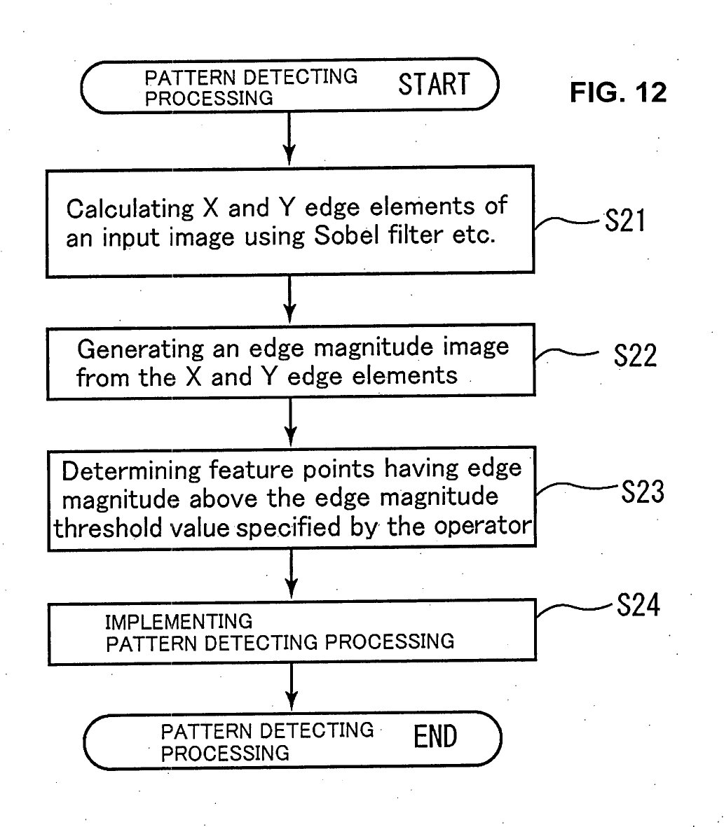

FIG. 13 shows a image of a printed circuit.

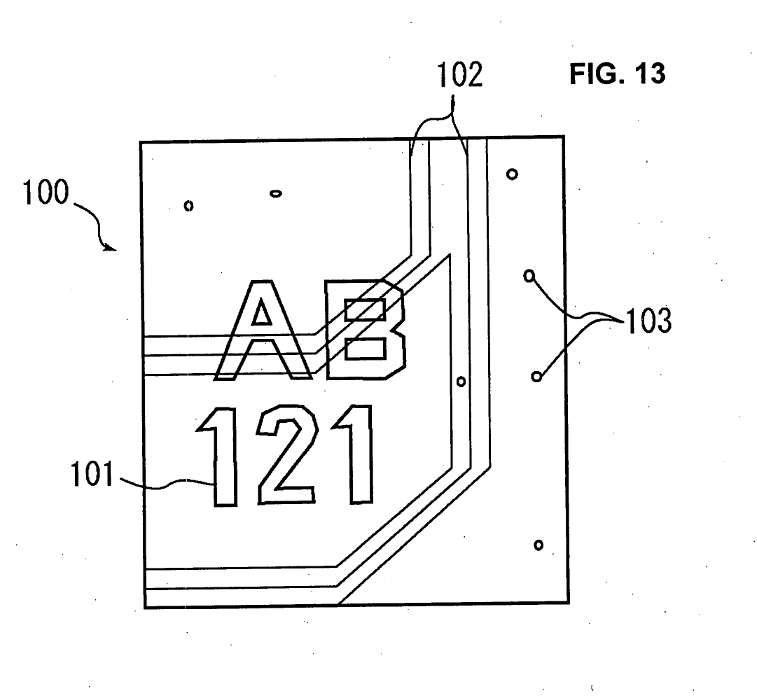

FIG. 14 shows a graph of a frequency distribution of a prior art search technique where the edge magnitude threshold value is set low.

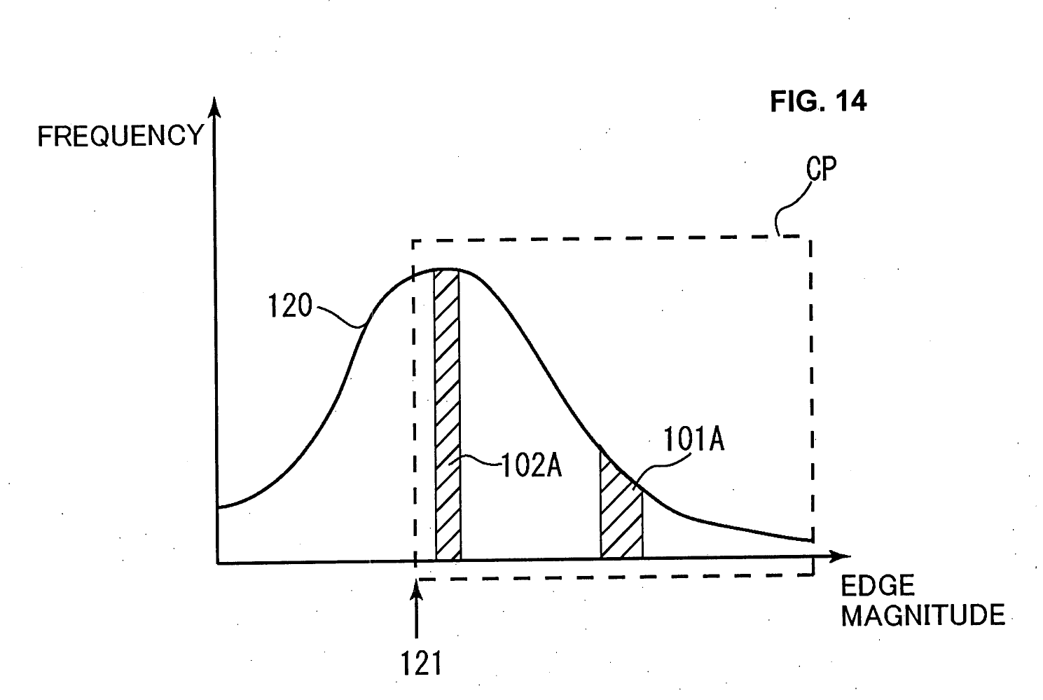

FIG. 15 shows a graph of a frequency distribution of a prior art search technique where the edge magnitude threshold value is set high and in a bright environment.

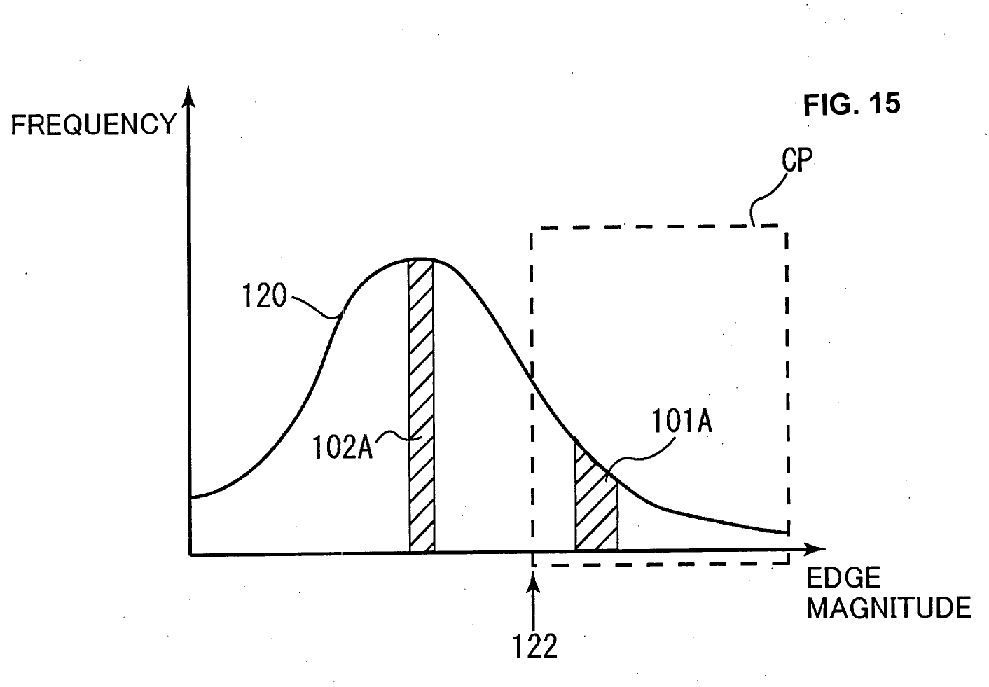

FIG. 16 shows a graph of a frequency distribution of a prior art search technique where the edge magnitude threshold value is set high and in a dark environment.

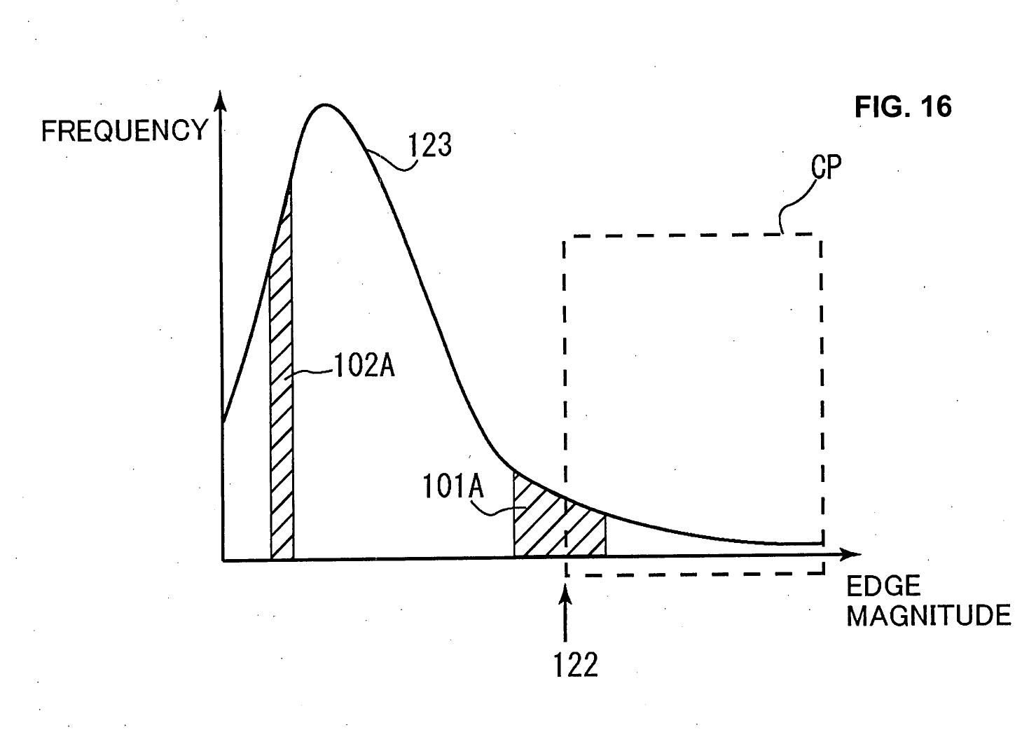

### DETAILED DESCRIPTION OF THE INVENTION

[The Structure of the Machine Vision System]

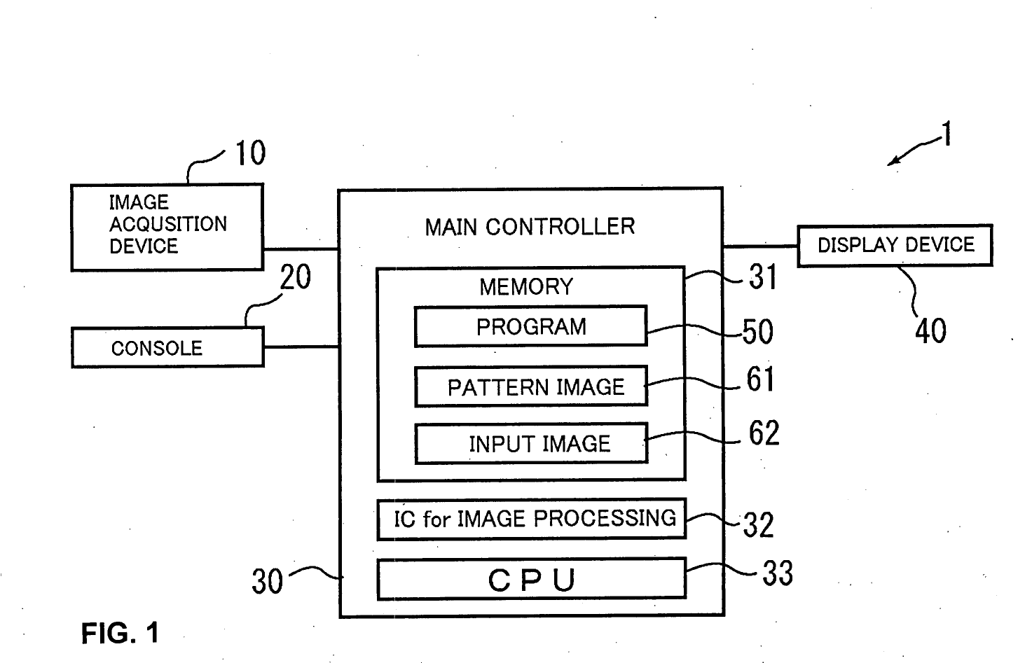

The preferred embodiments of present invention, especially the case of pattern search processing, will be described with reference to the figures hereinafter. FIG. 1 shows a block diagram of the machine vision system 1 regarding one preferred embodiment of the invention.

The machine vision system 1 comprises an image acquisition device 10, a console 20, a main controller 30 and a display device 40. For example, the image acquisition device 10 includes a plurality of CCD acquisition elements. The console 20 is a keyboard connected to or integrally made on the main controller 30. The main controller 30 comprises a memory 31, an IC for image processing 32 and a CPU 33 to control the machine vision system 1. The display device 40 is a LCD connected to or integrally made on the main controller 30.

Hereinafter, an outline of the pattern search processing carried out on the machine vision system 1 will be explained. The machine vision system 1 stores an image including features as a pattern image to be detected in the memory 31. Then, an input image 62 as an object to be processed is acquired by the image acquisition device 10 and is also stored into the memory 31. Then, a program 50 installed into the memory 31 is carried out on the CPU 33 to detect a feature in the input image 62 which is matched or similar to the pattern image 61.

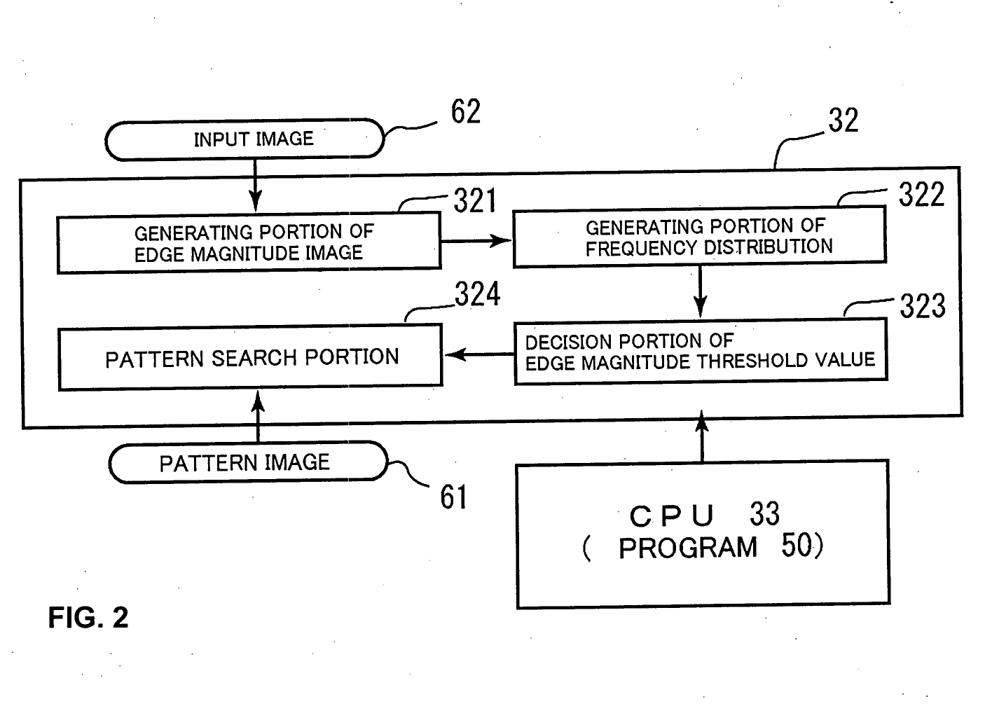

FIG. 2 shows a functional block diagram of the IC for image processing 32. The IC for image processing 32 comprises an edge magnitude image generating portion 321, a frequency distribution generating portion 322, an edge magnitude threshold value decision portion 323 and a pattern search portion 324. The functions of these portions of the IC for image processing 32 will be described below. In another preferred embodiment, the CPU 33 executing a program 50 implements the function of the above-mentioned portions of the IC for image processing 32.

For example, the machine vision system 1 is used in the inspection area of the manufacturing line of a factory to execute the pattern search processing with an acquired image of the product conveying continuously down the line. The inspection is carried out. The inspection result is determined whether the input image 62 is matched with the pattern image 61 or not.

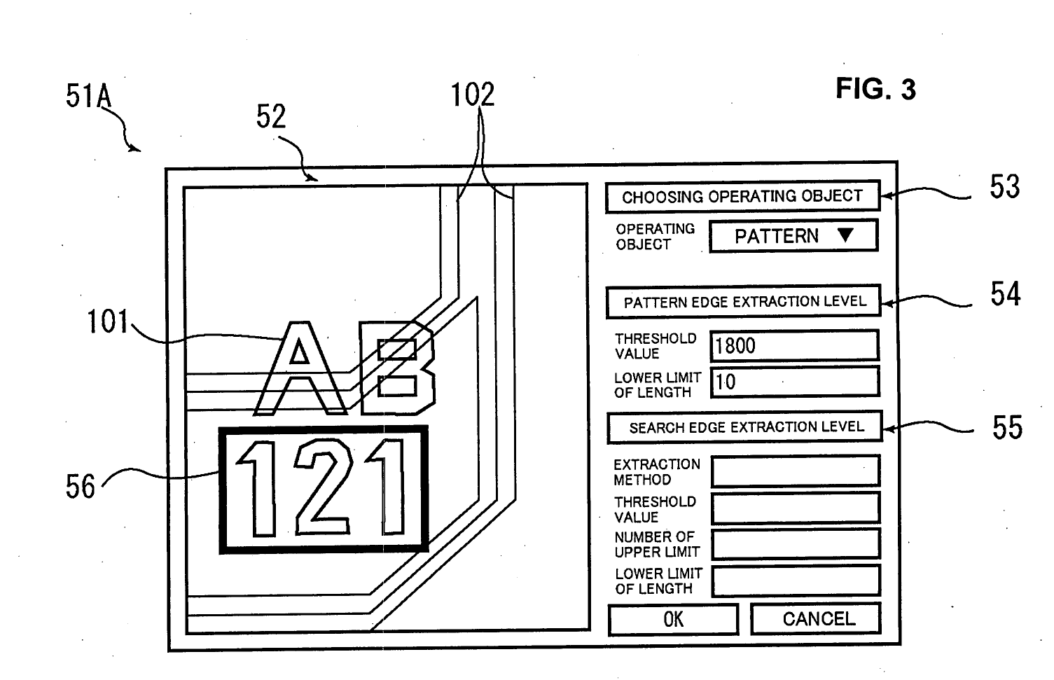

The pattern search processing according to the present invention includes a method for pattern search processing using the above-mentioned machine vision system 1 with reference to FIG. 3 through FIG. 8.

A multi-bit image regarding an object to be searched is acquired as the pattern image 61 to implement the pattern search processing. FIG. 3 shows a user interface (UI) showing a pattern image acquisition display portion 51A displayed on the display device 40 which is able to switch and display the pattern image 61 and the edge element image generated based on the pattern image 61. Each user interface picture (shown in FIGS. 3, 4 and 9) displayed on the display device 40 by the program 50 comprises an image displaying area 52, an operating object selection area 53, a designated area for a pattern edge extraction level 54 and a designated area for a search edge extraction level 55 in a common area.

The pattern image acquisition display portion 51A in FIG. 3 shows “PATTERN” as an image when it is selected as the operating object to select a pattern model and set parameters for defining the pattern model processing conditions. After choosing “PATTERN”, a threshold value stored as a default value, for example 100 (not shown), in the memory 31 is displayed in an input column for a threshold value of the designated area of pattern edge extraction level 54 described below. A lower limit of length stored as default value, for example 10 (not shown), in the memory 31 is also displayed in an input column for a lower limit of length of the designated area of the pattern edge extraction level 54. It may be possible to input a value from 40 to 8,000 in the input column for the threshold value, and to input a value from 0 to 200 in the input column for the lower limit of the designated area of the pattern edge extraction level 54.

As the designated area of the pattern edge extraction level 54 shown in FIG. 3, 1,800 is set as the input threshold value instead of the above-mentioned default value; 100. Also 10 is set as the input lower limit instead of the default value. Then, the pattern image 61 or the edge magnitude generated based on the pattern image 61 is displayed in the image displaying area 52. It is possible to choose at least one of the pattern image 61 and the edge magnitude generated based on the pattern image 61 with a button on the display (not shown) or preset an initial condition for the image of the image displaying area 52.

Preferably the system automatically switches from the pattern image 61 to the edge magnitude image based on each of the following operating activities. One operating activity is to select “PATTERN” as the operating object with the fixed default values, a second activity is to input the desired value of the designated area of the pattern edge extraction level 54 by an operator, and a third activity is to push the “OK button” meaning completion of the setting regarding the input column of the designated area of the pattern edge extraction level 54.

The method for generating the above-mentioned edge magnitude image is as follow. First, the threshold value is set as the extracting level regarding the pattern edge. Second, the edge point having the edge magnitude above the threshold is extracted. Third, a thinning process to obtain a thin line extracts only a local maxima 80 and omits others that surround the local maxima 80 automatically to extract the true edge points. Then, after the process to obtain the thin line, the edge magnitude image based on the edge points is displayed.

The object in the pattern image 61 shown in FIG. 3 includes a printed character 101, a circuit pattern 102 and so on. Then, the operator selects characters “121” to be searched as the pattern model using a rectangular area 56 in the pattern image 61. A rectangular frame for specifying the rectangular area 56, so-called “rubber band”, has flexibility regarding its size and shape to fit the figure, character, etc. to be specified as the pattern model by the operator. While “PATTERN” is chosen as the operating object in the pattern image acquisition display portion 51A, the designated area of the search edge extraction level 55 for an input image is enabled access since “PATTERN” includes choosing and setting for the pattern model. The designated area of the search edge extraction level 55 is also displayed with a gray tone to indicate the situation when it is impossible to access.

As mentioned above, the operator chooses the rectangular area 56, including the image (such as a figure, character, etc.) to be specified as the model pattern using the rectangular frame. The operator also specifies the threshold value and the lower limit of length as a pattern edge extraction level. The threshold value is used to specify the point in the pattern 61, and the point in the rectangular area 56 in more detail, that is above the threshold value as an edge point to be extracted.

The “length” means a length of a series points which have an edge magnitude above the threshold value. To specify the “lower limit of length” means to exclude the series edge points that have a length shorter than lower limit of length from the object edge points of the pattern image 61. In other words, the edge points corresponding to scar are omitted from the pattern image 61.

In general, various kinds of methods for connecting edge points are well known. In this embodiment, a first step of the method is calculating the orthogonal direction to a vector direction of a starting edge point. A second step is determining whether the edge point exists in the neighbor pixel arranged in the above-mentioned orthogonal direction and the right and left neighbor pixels of the neighbor pixel within the eight contiguous pixels to the starting edge point. A third step is analyzing the similarity between the vector direction of the starting edge point and the neighbor pixel having the edge point determined in the previous step when the result of determining in the previous step is that the neighbor pixel having the edge point exists. A fourth step is connecting the starting edge point to the neighbor pixel having a high similarity to the edge point. Next, the search of the connectable edge points is repeated from the first step to the fourth step based on the connected pixel as a renewed starting edge point.

The edge elements of the horizontal direction (X direction) and the vertical direction (Y direction) may be calculated using a Sobel filter with the pattern model. The edge magnitude image and the edge angular image may be generated from the edge elements.

In other words, first, the edge elements of each pixel are calculated in two directions, the X direction and the Y direction. Next, the edge magnitude image and the edge angular image are respectively generated based on the edge magnitude and the edge angular value of each pixel calculated from the two edge elements. In more detail, the edge magnitude image is generated based on the edge points having an edge magnitude above the threshold value, which is a default value or an input value in the input column of the designated area of the pattern edge extraction level 54.

The edge magnitude image may be generated to display on the image displaying area 52 of the pattern image acquisition display portion 51A or to use it for matching with the edge magnitude image generated from the input image described later. In this embodiment, the edge magnitude image is displayed on the image displaying area 52 of the pattern image acquisition display portion 51A and is also used for matching described later.

It is preferred to match the data of the edge magnitude image using data represented geometrically. In more detail, the geometric data geometrically describe two dimensional coordinates, the edge magnitude and the vector direction at each edge point. Then, the geometric data is matched with the edge magnitude image to be searched. To connect edge points is executed based on the vector direction of each edge point.

After the above-mentioned setting is finished, when the operator pushes the “OK button” of the pattern image acquisition display portion 51A, the pattern model specified in the rectangular area 56 on the pattern image 61 by the operator and the above-mentioned geometric data are stored into the memory 31.

The optimum setting of the threshold value for the pattern model is to input the above-mentioned threshold value and the lower limit and to display the edge magnitude image based on these values on the image displaying area 52 in response to their input. It is possible for the operator to set a desired value as the threshold value and the lower limit of length by repeating the input of these values based on confirming the displayed content.

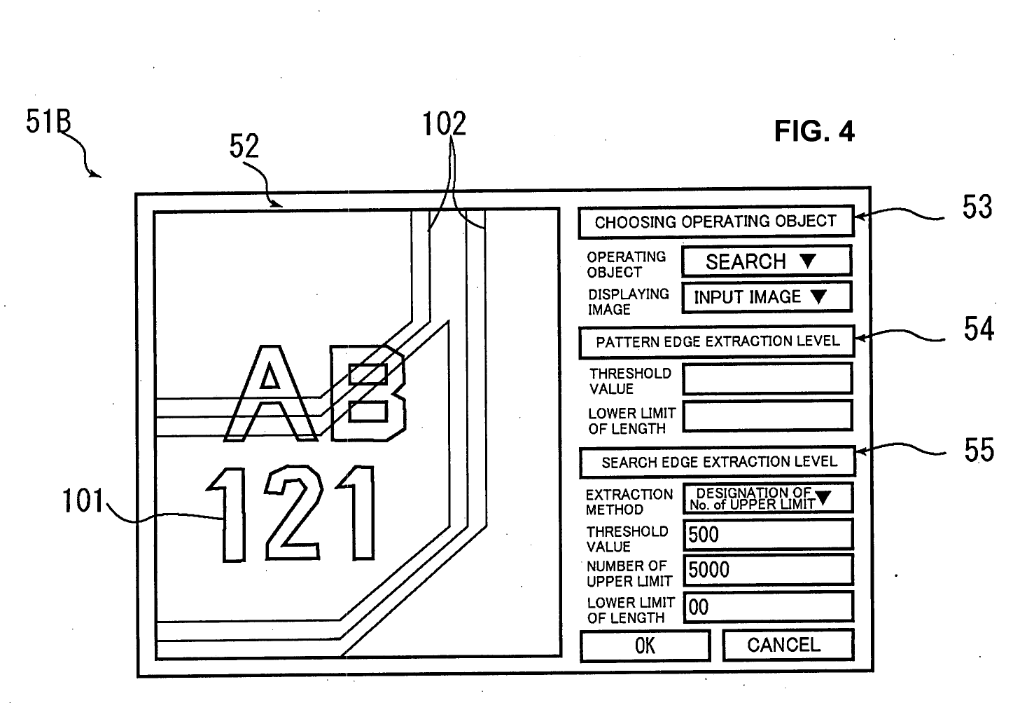

The setting flow for extracting the features as the edge points when “SEARCH” is selected as the operating object with reference to FIGS. 4 through 6 will now be explained. FIG. 4 shows a diagram regarding a user interface (UI) showing a pattern search display portion 51B displayed on the display device 40 by implementing the program 50. In this situation, “SEARCH” is chosen as the operating object. The “INPUT IMAGE” is also designated as the displaying image. The input image 62 which is the object to be processed is displayed on the image displaying area 52. In other words, the object image acquired by the image acquisition device 10 is stored in the memory 31 as the input image 62. The input image 62 is displayed on the image displaying area 52 as the image to be operated. In more detail, these aspects may be set at a specific location of the manufacturing line where the machine vision system 1 comprising the image acquisition device 10, the display device 40 and the main controller 30 is located. As the result, the input image from the image acquisition device 10 is provided under a specific condition such as a specific illumination condition.

At the time of choosing “SEARCH” as the operating object, a threshold value stored in the memory 31 as the default value, for example 100 (not shown), is displayed on the input column of the designated area of the search edge extraction level 55 for the designated value of the number of the upper limit. Further, a designated value of the number of the upper limit stored in the memory 31 as the default value, for example 8,000 (not shown), is also displayed on the input column for the designated value of the number of the upper limit of the designated area of the search edge extraction level 55. In the same situation, a designated value of the lower limit of length stored in the memory 31 as the default value, for example 4 (not shown), is also displayed on the input column of the designated area of the search edge extraction level 55 for the designated value of the lower limit of length.

The operator is able to input a value from 40 to 8,000 in the input column for the threshold value, and to input a value from 0 to 60,000 in the input column for the number of the upper limit of the designated area of the search edge extraction level 55, and to input a value from 0 to 200 in the input column for the lower limit of the designated area of the search edge extraction level 55. In this embodiment, as the designated area of the search edge extraction level 55, “500” is set as the “threshold value” and is changed from the default value, “5,000” is set as the “number of the upper limit” and is changed from the default value, and “5” is set as the “lower limit of length” and is changed from the default value.

The explanation regarding the threshold value and the lower limit of length have been omitted since these meanings are the same as the above-mentioned designated area of the pattern edge extraction level 54. On the other hand, the meaning of the “number of the upper limit” is described hereinafter. The method for generating the above-mentioned edge magnitude image is the following. The threshold value is set as the extracting level regarding the pattern edge. After that, the edge points having the edge magnitude above the threshold are extracted. Then, the thinning process to obtain a thin line which extracts only the local maxima 80 and also omits neighboring edge points adjacent to the local maxima 80 extracts the edge points automatically. Then, after the process of obtaining the thin line, the edge magnitude image based on the edge points is displayed.

The designated area of the pattern edge extraction level 54 is displayed with a gray tone to indicate the situation when it is impossible to access.

The optimum setting of the values of the threshold, the number of the upper limit and the lower limit of length are achieved by repetition of inputting each value corresponding to the threshold, the number of the upper limit and the lower limit of length and checking the display of the edge magnitude image based on these values on the image displaying area 52.

In a preferred embodiment, it is desired that the default value of the threshold value when “SEARCH” is selected as the operating object is equal to or less than the default value of the threshold value when “PATTERN” is selected as the operating object. The illumination environment for acquiring the input image as the “SEARCH” object has the possibility of being noisier because of the environment for acquiring the input image than the “PATTERN” object. This is also because the input image as the “SEARCH” object may be taken at a specific location of some manufacturing line or the like.

In the preferred embodiment, the default value of the lower limit of length when “SEARCH” is selected as the operating object is equal to or more than the default value of the lower limit of length when “PATTERN” is selected as the operating object for the same reason as the above-mentioned threshold value case.

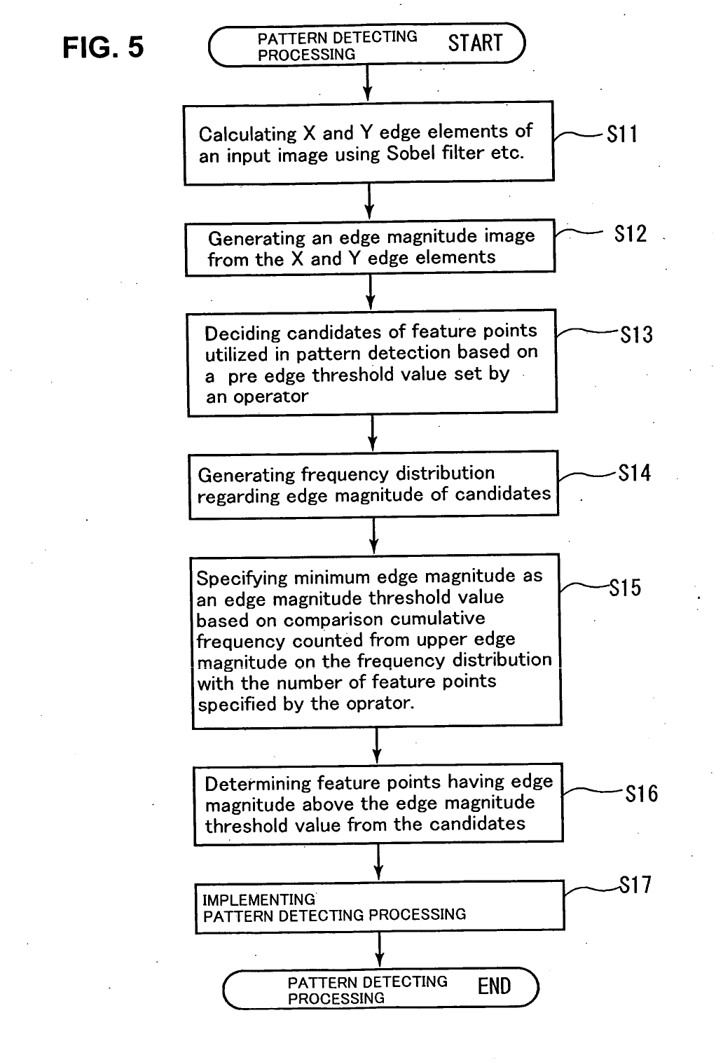

The above-mentioned setting is done by the operator, and then the process shown in FIG. 5 is implemented when the “OK button” on the pattern search display portion 51B is chosen. The process is mainly implemented by the IC for image processing 32. In another embodiment, a part of the process is implemented by the program 50.

A generating portion of the edge magnitude image 321 shown in FIG. 2 generates the edge element image using the input image 62 read from the memory 31 (Step S11). The generating portion of the edge magnitude image 321 calculates the edge element of the horizontal direction (X direction) and the vertical direction (Y direction), for example by using a Sobel filter. Then, the generating portion of the edge magnitude image 321 generates the edge magnitude image and the edge angular image from the edge element (Step S12). In other words, in Step S11, the edge elements of each pixel are calculated in two directions, the X direction and the Y direction. At Step S12, the edge magnitude image and the edge angular image are respectively generated based on the edge magnitude and the edge angular value of each pixel calculated from the two edge elements. In more detail, the edge magnitude image and the edge angular image are generated in the same as the manner above-mentioned process for generating the image of the model pattern.

A generating portion of the frequency distribution 322 determines an edge point having an edge magnitude above the specified threshold value which is a pre edge magnitude threshold value and is designated as the threshold value regarding the edge magnitude of the designated area of the search edge extraction level 55, as having a possibility of being a candidate for a feature point when processing the object to be searched (Step S13). The pre edge magnitude threshold value means a lower limit value of the edge magnitude provisionally set in the previous step of determining the edge magnitude threshold defining a range of feature points. The provisional lower limit is used for omitting the points having a low edge magnitude which have a high possibility of being noise.

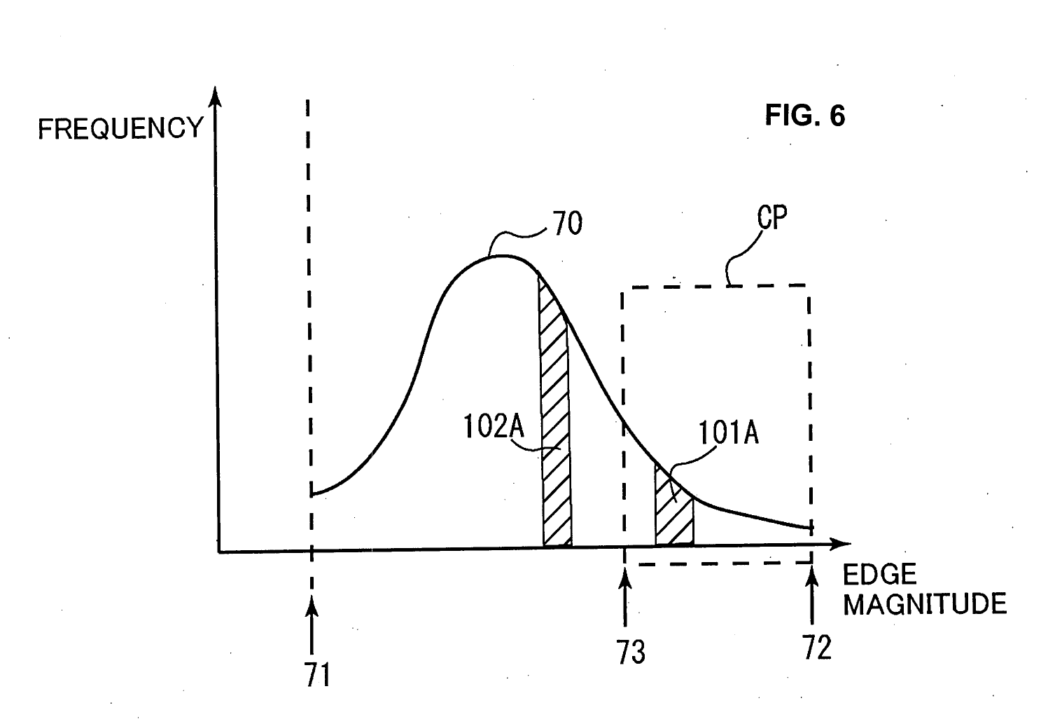

The generating portion of the frequency distribution 322 generates a frequency distribution 70 like a histogram as shown in FIG. 6 corresponding to the edge points having the edge magnitude above the designated threshold value as the feature values (Step S14).

As shown in FIG. 6, the generating portion of the frequency distribution 322 generates the frequency distribution 70 corresponding to the edge points having the edge magnitude above the pre edge threshold which is the designated threshold value regarding the edge magnitude input in the designated area of search edge extraction level 55. In other words, the frequency distribution 70 is generated based on the candidates of the feature points designated by the operator. In this embodiment, since the frequency distribution 70 is generated from the edge points which have a larger edge magnitude than the pre edge magnitude threshold value 71 designated by the operator, edge points having a small edge magnitude can be omitted as noise from the frequency distribution 70. This generates the frequency distribution 70 and carries out the following processing with a high speed.

The decision portion of the edge magnitude threshold value 323 counts up frequency, the number of the edge points, of each edge magnitude from the high side of the edge magnitude on the frequency distribution 70 to the lower side. Then, the decision portion of the edge magnitude threshold value 323 compares the cumulative number added up from the high side of the edge magnitude to each edge magnitude with the designated number of the feature points. The decision portion of the edge magnitude threshold value 323 decides the lowest edge magnitude in the edge magnitude to which the cumulative number added up from the high side of the edge magnitude is not over or the same to the designated number of the feature points as the edge magnitude threshold value 73.

The number of the feature points is the value designated as the “number of the upper limit” in the designated area of the search edge extraction level 55 of the pattern search display portion 51B by the operator. In other words, the lowest edge magnitude in the edge magnitude to which the cumulative number added up from the maximum value of the edge magnitude 72 is not over or the same to the designated number of the feature points is decided as the edge magnitude threshold 73. Then, the decision portion of the edge magnitude threshold value 323 decides the pixels having the edge magnitude above the edge magnitude threshold 73 as the feature points (Step S16). Therefore, as shown in FIG. 6, the points included in the area CP surrounded by the broken line are the feature points of the search object.

When the above-mentioned process is completed, a pattern search portion 324 reads the pattern image 61 from the memory 31. Then, the pattern search portion 324 processes the pattern search at the search object image having the feature points using the pattern model in the memory 31 generated from the pattern image 61. The specific method of the pattern search is not limited. For example, it may be a method for calculating the pixel differential value at a plurality of coordinate positions of the search object image between the pattern image and the search object image, and acquiring the coordinate position at which the pixel differential value is minimized. It is preferred to processing the matching with the pattern image 61 expanded, reduced or rotated. In more detail, the more accurate result is acquired by searching in the edge image generated from input image 62 with the model pattern using not only the edge magnitude but also the edge angular value of each input image 62 and the model pattern.

As mentioned above, in this embodiment, the method for deciding the feature points for the processing object of the pattern search is a characteristic. Specifically, the range including the feature points is determined based on the edge magnitude threshold value designated by the operator and is not fixed. In other words, the edge magnitude threshold value is not specified as a fixed value, but depends on the distribution condition of the edge magnitude of the input image 62. The edge magnitude threshold value is decided based on the cumulative number of the edge points added up from high side of the edge magnitude. Then the cumulative number is specified prior to deciding.

In the above-mentioned embodiment, the maximum value of the edge magnitude of the frequency distribution is adopted as the edge magnitude of the starting point to be added up. The number extracted is counted from the maximum value to the lower value. In another embodiment, it is also preferred that the average edge magnitude value of the frequency distribution consists of edge points having an edge magnitude above the pre edge threshold value as the edge magnitude of the starting point to be added up. Then, it is preferred to count from the lower value or the upper value. It is more preferred to count from the starting point to be added up from the lower and upper values evenly. In another embodiment, the particular rate of the pre edge threshold value is adopted as the edge magnitude of the starting point to be added up. The counting method is the same as the average edge magnitude value.

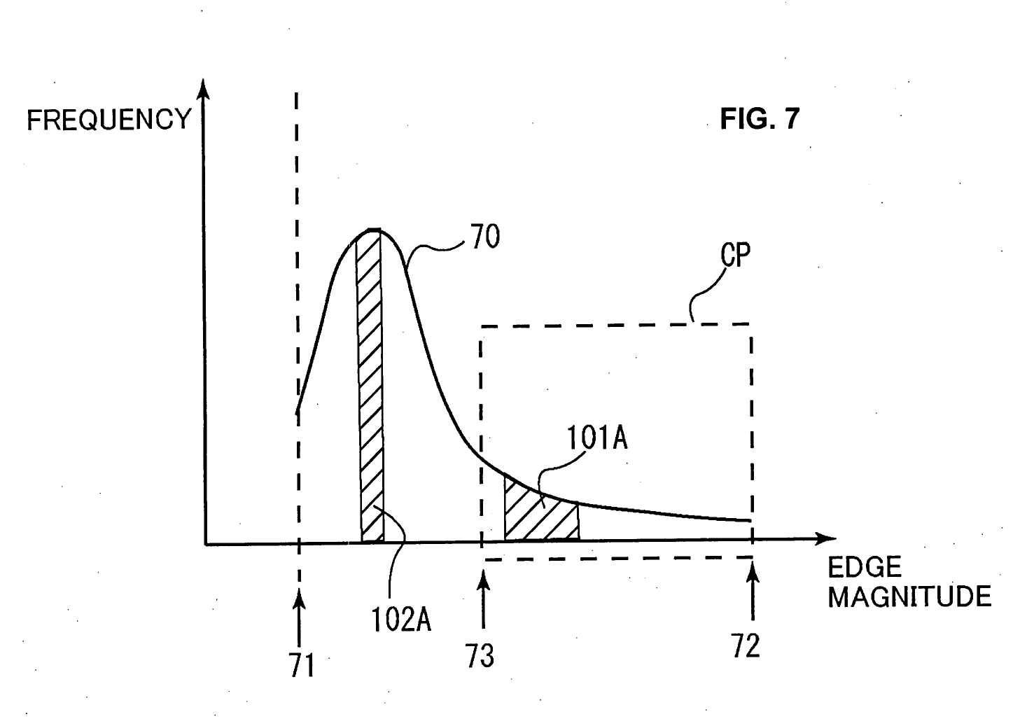

The above-mentioned technology prevents the problem in the conventional system where a narrow distribution of the edge magnitude regarding the input image 62 is caused by a dark environment, when it is acquired. FIG. 7 shows the frequency distribution 70 of the edge magnitude in a case that it has acquired the same object as in FIG. 6 under a darker environment. The distribution of the edge magnitude is shifted to the left side compared to the one shown in FIG. 6. Therefore, if it is omitted the printed character 101 to be searched from the feature point, in detail, if it is adopted the same value of the threshold set in FIG. 6 to the threshold for the frequency distribution 70 shown in FIG. 7, the edge magnitude area 101A of printed character 101 is lapped from the area of the feature points CP.

In this embodiment, however, the edge magnitude threshold value 73 is determined corresponding to the number of the feature points specified by the operator. As shown in FIG. 7, since it is fewer than the number of the feature points having a high edge magnitude, inevitably, the edge magnitude threshold value 73 is lower than the one in FIG. 6. Then, the edge magnitude area 101A is included in the area of the feature points CP. In this embodiment, the detection ability regarding the pattern search is not reduced even if the searching object image has a lower edge magnitude in all the pixels caused by fluctuation in the environment.

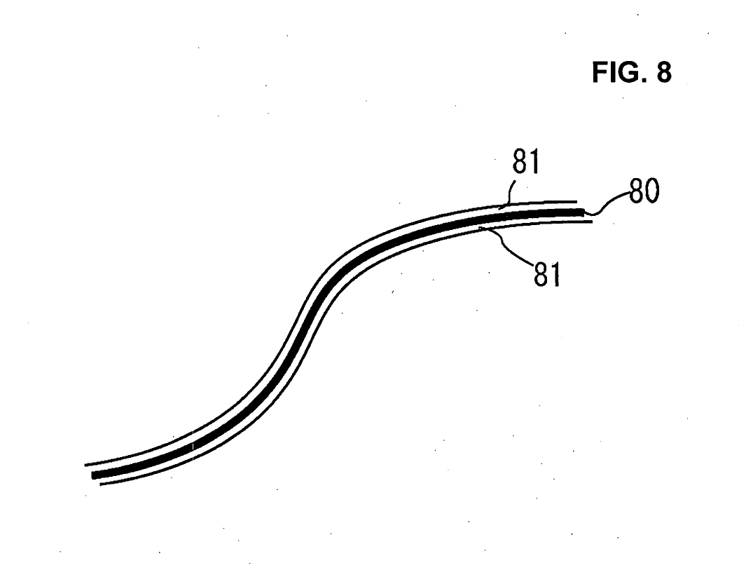

In this embodiment, the feature point is a pixel which has the edge magnitude equal to or above the edge magnitude threshold value determined corresponding to the number of the feature points specified by the operator. It is preferred to omit the edge points surrounding the local maxima regarding the edge magnitude from the processing object. As shown in FIG. 8, the points extracted as an edge comprise a group 80 of local maxima regarding the edge magnitude and a group 81 of points surrounding the local maxima.

In other words, in some case, an edge point in some pixel has the neighbor edge point in the neighbor pixel at the edge angular direction of the edge point. In such a case, if the frequency distribution includes the edge and the neighbor edge points having the edge magnitude above the threshold value, the neighbor edge points are possibly noise. Therefore, after it is extracted that all of the edge points having the edge magnitude above the threshold value, it is preferred to execute the thinning process as known in general prior to generating the frequency distribution. As the result, it is preferred to generate the frequency distribution consisting of a group of points 80 which are local maxima and do not include the group of points 81.

In this embodiment, the operator specifies the number of the feature points. Then, the edge magnitude threshold value is calculated corresponding to the number of the feature points counted from the maximum of the edge magnitude. A starting value for adding the number of the feature points is not limited to the maximum of the edge magnitude. For example, it may be set to a value subtracted from a specific value or a specific number of feature points from the maximum of the edge magnitude (an offset maximum value) as the starting value. In another embodiment, at first, some percentage of the feature points, for example 1% or 2%, the top of edge magnitude are removed. After removing the above-mentioned feature points, the maximum of the edge magnitude of the renewed frequency distribution may be set as the starting value. In another embodiment, the starting value can be specified by the operator or it can be set as a default value.

[Histogram Indication]

As mentioned above, in this embodiment, the edge threshold value is determined corresponding to the distribution condition of the edge magnitude. Further, a method for determining the optimum edge magnitude threshold will be explained.

In Step S14 of FIG. 5, the frequency distribution generated by the generating portion of frequency distribution 322 is not displayed on the display device as the graph. However, the frequency distribution can be displayed as the histogram shown in FIG. 6 on the display device 40 and the pre edge threshold value specified by the operator and the edge magnitude threshold value 73 corresponding to the number of the feature points specified by the operator can be displayed on the display device 40.

Therefore, the operator can realize the condition of the edge magnitude image generated from the input image 62 and the relationship of the parameters set corresponding to these conditions. The operator can choose to continue the process or to repeat the same operations with reference to these conditions and their relationship and view them.

In another embodiment regarding the histogram displayed on the display device 40, the operator specifies the specific edge magnitude value directly on the displayed histogram. Then, the edge points having the edge magnitude above the edge magnitude value are determined as the edge points finally specified. In this case, after counting the edge points having the edge magnitude above the edge magnitude value specified on the display device 40, the number of the edge points is automatically set as the number of the upper limit regarding the edge points. It is preferred to set the above mentioned base value of the edge magnitude and the upper or the lower limit corresponding to the base value on the display device 40.

[The Designation for the Connecting Number]

The designation of the connecting number is explained as follows. Especially, it will be explained about a method for designating a connecting number to the “lower limit of length”.

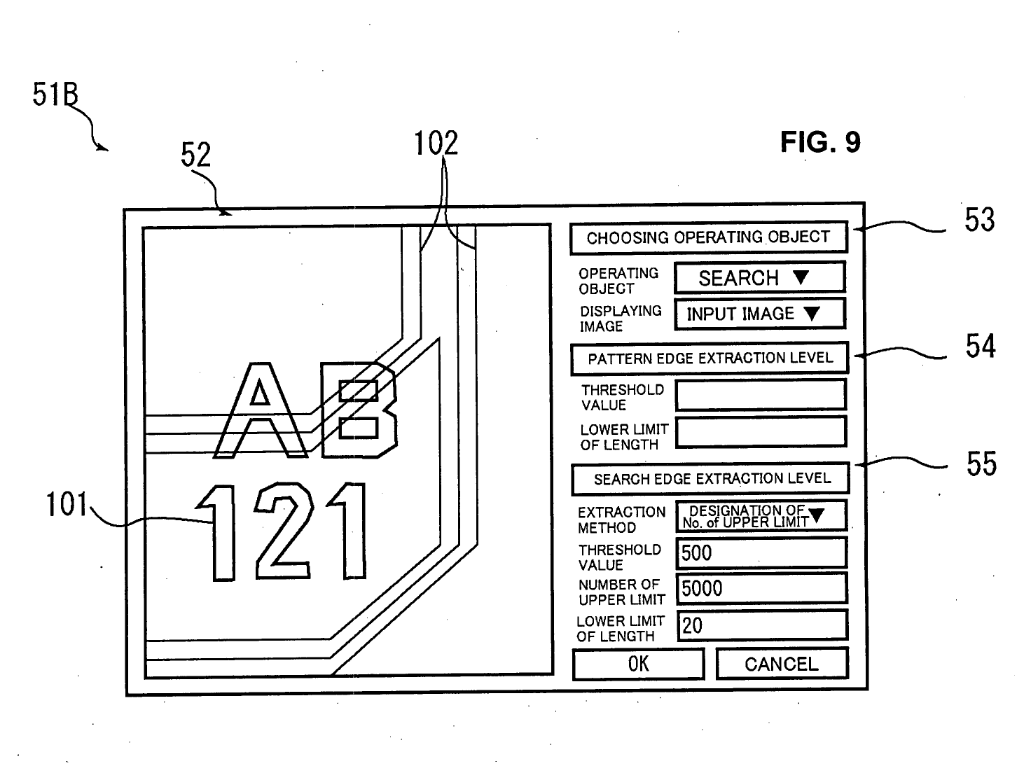

FIG. 9 shows a user interface regarding specifying the “lower limit of length” on the pattern search display portion 51B. Numeral “20” is set as the “lower limit of the length”. This means the connecting number of edge points is one of the extracting conditions of the feature points in addition to the edge magnitude threshold. For example, the extracting condition of “20” as the “lower limit of length” indicates the extracting conditions of the feature points that the edge points comprising an edge chain which consists of 20 or more edge points connected continuously are only admitted as the feature points.

Accordingly, in case of designating some specified number as the “lower limit of the length” on the pattern search display portion 51B, the edge points comprising the edge chain having the connecting number which is less than the specific number of the “lower limit of length”, are omitted from the feature points in the Step S16 shown in FIG. 5.

Thus, it is possible to omit the small points from the pattern search object, the scar and the noise regarding the machine vision from being part of the feature points. Accordingly, it is possible to improve the processing speed and the detecting performance of the pattern search.

[The Automatic Setting]

In the above-mentioned embodiment, the edge magnitude threshold value is determined corresponding to the distribution of the edge magnitude in response to the number of features specified by the operator. In another embodiment of the method, it is also preferred that the machine vision system 1 may set each parameter automatically.

For example, the number of the feature points may be set automatically based on the distribution condition of the edge magnitude in response to generating the frequency distribution of the input image 62 in the IC for image processing 32. Then, the edge magnitude threshold value is automatically determined and the pattern search is implemented. The algorithm of the automatic setting of the number of the feature points is, for example, a method for determining the number of the feature points based on the mean value of edge magnitude of the pattern image 61.

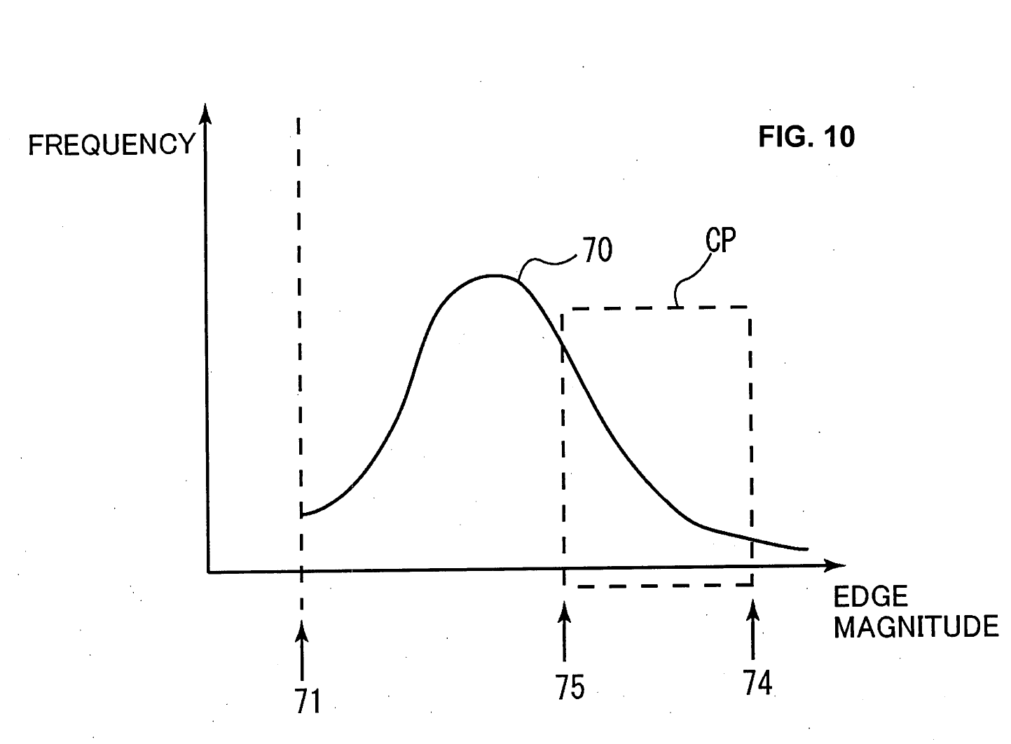

In the above-mentioned embodiment, the starting value of the edge magnitude is fixed to the maximum value of the edge magnitude to determine the edge magnitude threshold. In case of the embodiment as shown in FIG. 10, the starting value can be designated by the operator.

In other words, the operator can set the threshold value (pre edge threshold value 71) and the upper limit of the length as in the first embodiment as shown in FIG. 4. In this embodiment, in addition to these settings for the threshold value and the upper limit of the length, the operator can also set the upper limit value of the edge magnitude 74. Then, the decision portion of the edge magnitude threshold value 323 calculates the edge magnitude threshold value 75 corresponding to adding the feature points from the upper limit value 74 specified instead of the maximum value. After that, the pattern search is implemented to an area CP disposed between the edge magnitude threshold value 75 and the upper limit value 74.

In this embodiment, since the edge magnitude threshold value 75 is set variably, the detecting performance of the pattern search is able to be maintained even if the frequency distribution is varied based on the influence of illumination. To designate the upper limit value 74 can remove an extraordinary point having an extremely high edge magnitude from the processing object. In other words, it can be said that the method calculates the edge magnitude threshold value based on adding the number of the feature points from the offset maximum value.

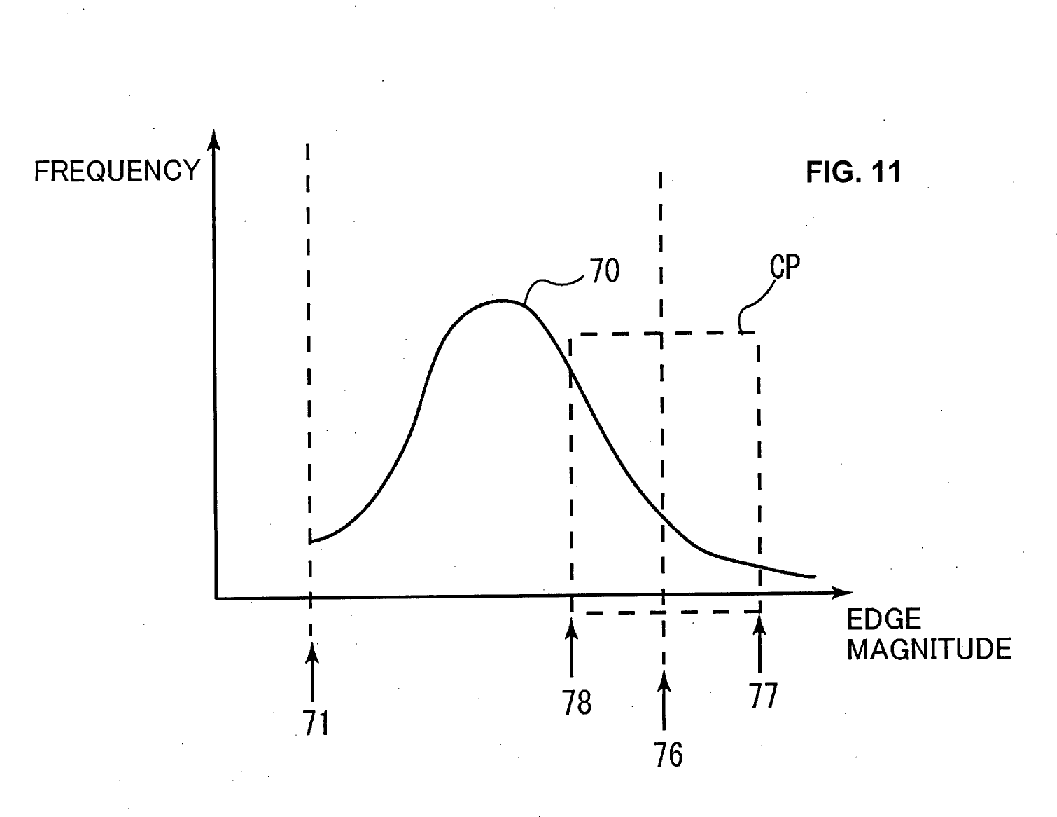

Another preferred embodiment of the present invention will be explained with reference to FIG. 11. This embodiment calculates the mean value of the edge magnitude 76 of the pattern image 61, and then calculates the upper threshold value 77 and the lower threshold value 78 of the edge magnitude corresponding to the mean value of edge magnitude 76. In this case, the operator sets the threshold (the pre edge threshold value 71) and the number of the upper limit (the number of the feature points) in the same way as the case shown in FIG. 4.

The decision portion of the edge magnitude threshold value 323 adds the number of the feature points, specified by the operator, which are divided in an upper side and a lower side of the mean value of edge magnitude 76 as a median (For example, each half of the number of the feature points is added to the upper side and the lower side respectively). After that, the upper threshold value 77 and the lower threshold value are calculated respectively. The pattern search is implemented using the feature points comprised in the area CP between the upper threshold value 77 and the lower threshold value 78.

According to this method, it is possible to implement the pattern search at the area close to the distribution of the edge magnitude of the pattern image 61. In the above-mentioned embodiment, the explanation presupposes that the user interface image (FIG. 3, FIG. 4 and FIG. 9) displayed on the display device 40 comprises the image displaying area 52, the operating object selection area 53, the designated area of the pattern edge extraction level 54 and the designated area of the search edge extraction level 55.

However, each user interface image may be displayed depending on each operating object. In other words, each user interface image may be displayed individually dependent on the respective input image to be searched. In this case, it may be sufficient to display the image displaying area 52 displaying the pattern image 61, the edge image corresponding to the pattern image 61 and the designated area of the pattern edge extraction level 54 as the user interface image for the pattern image. On the other hand, it may be sufficient to display the image displaying area 52 displaying the input image 62, the edge image corresponding to the input image 62 and the designated area of the search edge extraction level 55 as the user interface image for the input image.

In the above-mentioned first embodiment, when “PATTERN” is chosen, the “threshold value” corresponding to the edge magnitude value and the “lower limit of length” defined as the lower limit of the length of the connected edge points are adjustable as the parameters for calculating the edge magnitude image. On the other hand, when “SEARCH” is chosen, the “threshold value” corresponding to the edge magnitude value, the “number of the upper limit” specifying the number of edge points from the maximum value of the edge magnitude to limit the extracted points as the edge point and the “lower limit of length” are adjustable as the parameters for calculating the edge magnitude image.

In another embodiment, when each of “PATTERN” and “SEARCH” are chosen, it is possible for the operator to choose one mode from the following two modes.

A first mode is a mode for utilizing the “threshold value”. When the first mode is chosen, automatically the “threshold value” and the “lower limit of length” become adjustable based on inputting a specified number to each. At this time, the input column of the “number of the upper limit” is displayed with a gray tone which includes not accepting any inputs, since the “number of the upper limit” is not utilized.

An explanation regarding setting and the detailed technique of the “threshold value” and the “number of the upper limit” is omitted since this is the same as the above-mentioned first embodiment. A second mode is a mode for utilizing the “number of the upper limit” for specifying the number of edge points from the maximum value of the edge magnitude to limit the extracted points as the edge point. When the second mode is chosen, it is automatically enabled for the operator to adjust the “threshold value” and the “lower limit of length” based on inputting a specified number to each.

Then, an explanation regarding setting or the detailed technique of the “lower limit of the number”, the “threshold value” and the “number of upper limit” is omitted, since these are the same as the above-mentioned embodiment. Further, each parameter for input has a default value such as described above in the first embodiment.

The characteristic of this embodiment is adapting the image acquired corresponding to the “PATTERN” or the “SEARCH” to any acquiring environment and this is compatible with adjusting the above-mentioned parameters easily.

Since the image of the “PATTERN” is generally acquired under a proper illumination environment, the first mode is chosen and the edge magnitude image is acquired easily. On the other hand, since it is sometimes difficult that the image of the “PATTERN” is acquired under a proper illumination environment, the second mode can be chosen. In the same way as the image of the “PATTERN”, each of the first and second mode is selectable since any illumination environment is adapted in the case of acquiring the image of the “SEARCH”.

The process for extracting the features regarding this invention can be adapted not only to the pattern search processing illustrated in this embodiment, but also to automatic determining of the processing area, shape inspection, etc.

It is to be understood that although the present invention has been described with regard to preferred embodiments thereof, various other embodiments and variants may occur to those of the skilled in the art, which are within the scope and spirit of the invention, and such other embodiments and variants are intended to be covered by the following claims.

What is claimed is:

1. An image processing apparatus for extracting edge points in an input image acquired by an image acquisition device, the image processing apparatus comprising:
an edge magnitude calculating means for calculating an edge magnitude in each pixel of the input image,
a placing means for placing data of the edge magnitude calculated by said edge magnitude calculating means based on the edge magnitude,
a criterion edge magnitude value determining means for determining a criterion edge magnitude value as a criterion based on the data of the edge magnitude calculated by said edge magnitude calculating means,
an extraction number determining means for determining the number of the edge points to be extracted,
an edge magnitude threshold value specifying means for specifying an edge magnitude as an edge magnitude threshold value from the placed data of the edge magnitude corresponding to the criterion edge magnitude value and the number of the edge points to be extracted, and
an edge point extracting means for extracting a pixel having an edge magnitude to be extracted corresponding to the edge magnitude threshold value as one of the edge points in each pixel of the input image.

2. The image processing apparatus as claimed in claim 1, wherein said edge magnitude threshold value specifying means specifies an edge magnitude as the edge magnitude threshold value corresponding to the placed data of the edge magnitude based on the number of data of the edge magnitude from the criterion edge magnitude value and the number of the edge points to be extracted.

3. The image processing apparatus as claimed in claim 1, wherein said placing means generates a frequency distribution of the edge magnitude calculated by said edge magnitude calculating means as the placed data of the edge magnitude, and
said edge magnitude threshold value specifying means counts the number of the edge points to be extracted from the criterion edge magnitude value based on the frequency distribution and specifies the edge magnitude as the edge magnitude threshold value corresponding to the number counted.

4. The image processing apparatus as claimed in claim 3, the image processing apparatus further comprising:
a display means for displaying the frequency distribution, and
wherein said extraction number determining means determines the number of the edge points to be extracted corresponding to an area of the edge magnitude specified by an operator on the frequency distribution displayed by said display means.

5. The image processing apparatus as claimed in claim 1, wherein said extraction number determining means determines the number of the edge points to be extracted specified by an operator.

6. The image processing apparatus as claimed in claim 1, wherein said extraction number determining means determines the number of the edge points to be extracted corresponding to an area of the edge magnitude specified by an operator.

7. The image processing apparatus as claimed in claim 1, wherein the criterion edge magnitude threshold value is a maximum value of the edge magnitude calculated by said edge magnitude calculating means.

8. The image processing apparatus as claimed in claim 1, wherein the criterion edge magnitude threshold value is a value subtracted from a specific value or the specific number of the data of the edge magnitude from a maximum value of the edge magnitude calculated by said edge magnitude calculating means.

9. The image processing apparatus as claimed in claim 1, wherein the criterion edge magnitude threshold value is a mean value of the edge magnitude calculated by said edge magnitude calculating means.

10. The image processing apparatus as claimed in claim 1, wherein said edge magnitude threshold value specifying means specifies an edge magnitude as an edge magnitude threshold value from the placed data of the edge magnitude corresponding to the number of data of the edge magnitude from the criterion edge magnitude value toward an upper or lower side and the number of the edge points to be extracted, and
said edge point extracting means extracts a pixel having an edge magnitude to be extracted as the edge point corresponding to the edge magnitude threshold value and the criterion edge magnitude value in each pixel of the input image.

11. The image processing apparatus as claimed in claim 1, wherein said edge magnitude threshold value specifying means specifies a first edge magnitude as a first edge magnitude threshold value from the placed data of the edge magnitude corresponding to the number of data of the edge magnitude from the criterion edge magnitude value toward an upper side and the number of the edge points to be extracted and a second edge magnitude as a second edge magnitude threshold value from the placed data of the edge magnitude corresponding to the number of data of the edge magnitude from the criterion edge magnitude value toward a lower side and the number of the edge points to be extracted, and
said edge point extracting means extracts a pixel having an edge magnitude to be extracted as the edge point corresponding to the first edge magnitude threshold value and the second edge magnitude threshold value in each pixel of the input image.

12. The image processing apparatus as claimed in claim 1, the image processing further comprising:
a means for acquiring a pattern image including a specific pattern to be detected,
a means for calculating an edge magnitude in each pixel of the pattern image,
a means for extracting an edge point of the pattern image corresponding to the edge magnitude of the pattern image and an edge magnitude threshold value of the pattern image in each pixel of the pattern image,
a means for registering the edge points of pattern image as data of the edge points of the pattern image, and
a means for executing pattern search processing to the edge points of the input image using the registered data of the edge points of the pattern image.

13. The image processing apparatus as claimed in claim 1, wherein said edge magnitude calculating means calculates a first edge magnitude element in a first direction and a second edge magnitude element in a second direction orthogonal to the first direction corresponding to an intensity difference between a pixel and adjacent pixels in each pixel of the input image and calculates the edge magnitude and an edge angular direction corresponding to the first and second edge elements, and
the image processing apparatus further comprises;
a thinning means for omitting the edge points extracted by said edge point extracting means except for local maxima of the edge magnitude along the edge angular direction,
a connecting means for choosing an adjacent edge point to be connected corresponding to similarity between an edge point and the adjacent edge point adjacent to the edge point at each edge point obtained by said thinning means, and connecting the edge point to the adjacent edge point chosen,
a means for specifying a lower limit of the number of the edge points connected by said connecting means, and
an omitting means for omitting unconnected edge points and connected edge points having the number of the edge points connected by said connecting means less than a lower limit of the number of the edge points connected from the edge points to be extracted.

14. The image processing apparatus as claimed in claim 1, the image processing further comprising:
a means for designating a preliminary lower value of the edge magnitude, and
a means for omitting data of the edge magnitude lower than the preliminary lower value of the edge magnitude from the edge points.

15. The image processing apparatus as claimed in claim 1, wherein the edge magnitude threshold value is automatically set based on the number of the edge points to be extracted in response to acquiring the input image.

16. The image processing apparatus as claimed in claim 1, the image processing further comprising:
a means for displaying the input image and an image of the edge points extracted from the input image.

17. An image processing method for extracting edge points in an input image acquired by an image acquisition device, the method comprising:
calculating an edge magnitude in each pixel of the input image,
placing data of the edge magnitude calculated based on the edge magnitude,
determining a criterion edge magnitude value as a criterion based on the data of the edge magnitude calculated,
determining the number of the edge points to be extracted,
specifying an edge magnitude as an edge magnitude threshold value from the placed data of the edge magnitude corresponding to the criterion edge magnitude value and the number of the edge points to be extracted, and
extracting a pixel having an edge magnitude to be extracted as the edge point corresponding to the edge magnitude threshold value in each pixel of the input image.
